(19) United States
(12) Patent Application Publication
(10) Pub. No.: US 2023/0412284 A1
(43) Pub. Date: Dec. 21, 2023

(54) METHOD FOR COMMUNICATING INFORMATION, RECEIVER DEVICE, SENSOR DEVICE, AND SYSTEM

(71) Applicant: HELLA GmbH & Co. KGaA, Lippstadt (DE)

(72) Inventor: Volker WOESSMANN, Telgte (DE)

(73) Assignee: HELLA GmbH & Co. KGaA, Lippstadt (DE)

(21) Appl. No.: 18/241,577

(22) Filed: Sep. 1, 2023

Related U.S. Application Data
(63) Continuation of application No. PCT/EP2022/054696, filed on Feb. 24, 2022.

(30) Foreign Application Priority Data
Mar. 4, 2021 (DE) 10 2021 105 234.3

(51) Int. Cl. H04B 17/00; H04B 17/16; H04B 17/17

(52) U.S. Cl. CPC H04B 17/0085; H04B 17/16; H04B 17/17

(57) ABSTRACT

A method for communicating information, wherein two sensor devices each have a sensor test value generator with a variable value and with a calculation rule. The variable values and/or the calculation rules are different, and wherein a receiver device has a receiver test value generator with the two variable values and/or with the two calculation rules. The method includes: calculation of the sensor test value, generation of a data packet with the calculated sensor test value, receiving, by the receiver device, of the data packet from the sensor device, selection of the variable value and/or selection of the calculation rule, calculation of a receiver test value, and checking of the received sensor measurement information for a transmission error based on the received sensor test value and the calculated receiver test value.

This nonprovisional application is a continuation of International Application No. PCT/EP2022/054696, which was filed on Feb. 24, 2022, and which claims priority to German Patent Application No. 10 2021 105 234.3, which was filed in Germany on Mar. 4, 2021 and which are both herein incorporated by reference.

### BACKGROUND OF THE INVENTION

### Field of the Invention

The present invention relates to a method for communicating information, a receiver device, a sensor device, and a system composed of a receiver device and at least two sensor devices.

### Description of the Background Art

Motorists are placing ever greater demands on the modern motor vehicle. For instance, motorists demand improved steering accuracy in the area of motor vehicle safety. These demands can only be met with increased intelligence of the vehicle. Greater integration of sensor devices in the vehicle of tomorrow is thus indispensable. In order to achieve this, a system composed of a receiver device, for instance a control unit, and a sensor device or multiple sensor devices, for instance a steering sensor, wherein the receiver device and the sensor devices communicate information to one another, must fulfill numerous requirements such as reliability, robustness, accuracy, and/or speed.

The information to be communicated from one or more sensor devices of a motor vehicle can be transmitted to a receiver device of the motor vehicle in the form of a data packet. The data packet includes a certain number of bits for representing a sensor identification number so that the receiver device can associate received information with a sensor device. Furthermore, the data packet includes another certain number of bits for the sensor measurement information of the sensor devices to be transmitted. The transmission time for transmitting the information or the electrical binary signal from the sensor device to the receiver device can depend on the “length” of the information to be communicated or the total number of bits of the binary signal as well as on the information to be communicated. Disadvantageously, an excessively long transmission time reduces the efficiency of the system. Furthermore, external interference can at least partially change the information during communication of the information from the sensor device to the receiver device through a transmission channel. For instance, the sensor identification number and/or the sensor measurement information in the data packet can be changed by the external interference. Disadvantageously, the receiver device can incorrectly associate the received sensor measurement information in the case of a changed sensor identification number, with the result that reliable, safe function of a motor vehicle can be adversely affected.

### SUMMARY OF THE INVENTION

It is therefore an object of the present invention to at least partially overcome the above-described disadvantages. In particular, it is an object of the present invention to make possible an especially simple, safe, and fast communication of information between a sensor device or multiple sensor devices and a receiver device, in particular for a vehicle, preferably for a motor vehicle. An additional object of the present invention is to provide an especially simple, efficient receiver device, an especially simple, efficient sensor device, and an especially simple, efficient system for communicating information between a sensor device and a receiver device.

The above object is attained by a method and a receiver device with the, a sensor device, as well as a system. Of course, features and details that are described in connection with the method according to the invention also apply in connection with the receiver device according to the invention and/or with the sensor device according to the invention and/or with the system according to the invention and vice versa in each case, so mutual reference is or can always be made with regard to the disclosure of the individual aspects of the invention.

According to a first aspect, the present invention discloses a method, in particular for a vehicle, for communicating information between a sensor device of a system and a receiver device of the system, wherein the system has at least two sensor devices. Furthermore, the two sensor devices each have a sensor test value generator with at least one variable value and with a calculation rule for calculating a sensor test value from respective sensor measurement information to be communicated, wherein the variable values of the sensor test value generators and/or the calculation rules of the sensor test value generators of the two sensor devices are different. In addition, the receiver device has a receiver test value generator with at least the two variable values of the sensor test value generators and/or with at least the two calculation rules of the sensor test value generators of the two sensor devices. Moreover, the method has, at least as one step, a calculation of the sensor test value by the sensor test value generator, as a function of the variable value and/or as a function of the calculation rule, from at least the sensor measurement information to be communicated. Another step, in particular a subsequent step, of the method is a generation of a data packet, wherein the data packet has, at a minimum, a data section with the sensor measurement information to be communicated and a test section with the calculated sensor test value. Furthermore, a step, in particular a subsequent step, of the method is a sending of the data packet through a transmission channel to the receiver device. The method additionally has as a step, in particular as a subsequent step, a receiving by the receiver device of the data packet from the sensor device. Moreover, the method includes as a step, in particular as a subsequent step, the selection by the receiver device of the variable value of the sensor test value generator as a function of the sensor device and/or selection by the receiver device of the calculation rule of the sensor test value generator as a function of the sensor device, and also, as an additional step, in particular as a subsequent step, a calculation by the receiver test value generator of a receiver test value with the selected variable value and/or with the selected calculation rule from at least the received sensor measurement information to be communicated of the data section of the data packet. Furthermore, a step, in particular a subsequent step, of the method is a checking of the received sensor measurement information of the data section of the data packet for a transmission error based on the received sensor test value and the calculated receiver test value.

The method steps described above and those described below can be performed separately, together, once, repeatedly, chronologically in parallel, and/or sequentially in any desired order.

The method and/or the receiver device and/or the sensor device and/or the system is/are for, in particular, a vehicle, preferably for a motor vehicle such as an automobile. Furthermore, the method is, in particular, for communicating information between a multiplicity of sensor devices of a system according to the invention and at least one receiver device.

The features and details that one sensor device of the at least two sensor devices can have can, in particular, also include the other sensor device of the at least two sensor devices, and vice versa.

The sensor device can have at least one sensor for sensing measured values of a measurand. The sensor device has, in particular, at least two sensors that are each for sensing measured values of one measurand apiece, wherein the two measurands preferably are different measurands. One measurand can be, for example, an angle of a torsion bar required for the steering motion or a change of the steering angle and of the steering speed of a steering wheel of the vehicle. The sensor measurement information from the sensor device to be communicated includes, in particular, at least the sensed measured values of the measurand of the sensor or at least the sensed measured values of the measurands of the two sensors. Preferably, the sensor measurement information from the sensor device to be communicated is the sensed measured values of the measurand of the sensor or at least the sensed measured values of the measurands of the two sensors. Advantageously, a sensor device with two sensors can communicate information between the sensor device and the receiver device especially simply, economically, and efficiently.

The sensor test value generator can be implemented at least partly by hardware and/or at least partly by software. The sensor test value generator can be implemented at least partly by hardware through shift registers, for example. The sensor device can furthermore have, in particular, a storage on which the sensor test value generator of the sensor device is stored or saved at least partly by software. The variable value of the sensor test value generator and/or the calculation rule of the sensor test value generator can additionally be stored or saved on the storage. Furthermore, the sensor device can include a logic circuit for calculating the sensor test value. The logic circuit has, in particular, a processor for calculating the sensor test value and/or a microcontroller for calculating the sensor test value. The logic circuit can also (additionally) include flexibly programmable components such as FPGAs, EPLDs, ASICs, etc. Advantageously, a microcontroller can be especially cost-effective and efficient.

Moreover, the sensor device can have a data packet generator for generating the data packet. Furthermore, the sensor device can include a transmitting unit, wherein the transmitting unit is designed to send the data packet to the receiver device. In particular, the transmitting unit is designed to send the data packet as a digital signal, preferably as a binary signal, to the receiver device.

The test value is, in particular, a value with which the integrity of the information, in particular the integrity of the sensor measurement information to be communicated, can be checked.

A variable value of a test value generator is, in particular, a variable value of a calculation rule or a variable value for a calculation rule for calculating a test value, wherein the variable value is, in particular, a value that can be determined before the calculation of the test value, and wherein the calculated test value is, in particular, dependent on the variable value. The variable value can be an initial value of a calculation rule or an initial value for a calculation rule for calculating a test value. The initial value can also be understood as a seed value or a starting value for a calculation rule for calculating a test value. For instance, the variable value is an initial value (seed value) and/or a generator polynomial (value) for a cyclic redundancy check method (CRC method). It is therefore also possible that the sensor test value generator of a sensor device has, in particular, at least two variable values, wherein the test value is, in particular, dependent on the two variable values.

The calculation rule is, in particular, for calculating a test value, in particular for calculating the sensor test value or the receiver test value, from information, wherein the information is, in particular, the sensor measurement information to be communicated or the received sensor measurement information to be communicated. Furthermore, the calculation rule is to be understood as an algorithm, in particular. The calculation rule can be a CRC method, for instance. The CRC method can be especially effective in the detection of random errors. It is also possible that the calculation rule is a checksum method, in particular a checksum method that works with a weighted average value.

In the case of a CRC method as calculation rule, the sensor test value and/or the receiver test value can, in particular, each be a CRC test value, which are calculated in each case by the method of cyclic redundancy checking. In particular, in the cyclic redundancy check, data such as the sensor measurement information from a sensor device to be communicated is modulo divided by a generator polynomial by means of polynomial division, wherein the remainder from the division represents the CRC test value. Furthermore, the calculated CRC test value depends on the CRC initial test value and the generator polynomial. The CRC initial test value is, in particular, the initial value (seed value; starting value) for calculation of the CRC test value. For instance, in the cyclic redundancy check, data such as the sensor measurement information is modulo divided by the generator polynomial, wherein the division is implemented through shift registers, wherein, in particular, the CRC initial test value is the initial value of the shift register. Once the sensor measurement information is modulo divided by the generator polynomial, the CRC test value can be determined or “read out” from the shift registers as the remainder from the division, wherein the CRC test value is influenced by the choice of the CRC initial test value as a variable value and the choice of the generator polynomial as another variable value, or depends on the choice of the CRC initial test value and of the generator polynomial.

The receiver device can be, for example, a control module. The receiver test value generator has, in particular, at least one calculation rule for calculating the receiver test value. The receiver test value generator can be implemented at least partly by hardware and/or at least partly by software. The receiver test value generator can be implemented at least partly by hardware through shift registers, for example. The receiver device can furthermore have, in particular, a storage on which the receiver test value generator of the receiver device is stored or saved by software. At least the two variable values of the sensor test value generators and/or the at least two calculation rules of the sensor test value generators of the two sensor devices can additionally be stored or saved on the storage. Furthermore, the receiver device can include a logic circuit for calculating the receiver test value. The logic circuit has, in particular, a processor for calculating the receiver test value and/or a microcontroller for calculating the receiver test value. The logic circuit can also (additionally) include flexibly programmable components such as FPGAs, EPLDs, ASICs, etc.

Furthermore, the receiver device can have a selection unit. Moreover, the receiver device can include a receiving unit for receiving the data packet, wherein the receiving unit is designed to receive the data packet sent by the sensor device.

The phrase “wherein the receiver device has a receiver test value generator with at least the two variable values of the sensor test value generators and/or with at least the two calculation rules of the sensor test value generators of the two sensor devices” may be intended to express that the receiver test value generator can have at least two (different) variable values, wherein a first variable value of the at least two variable values of the receiver test value generator is identical to the variable value of a first sensor device of the two sensor devices, and wherein a second variable value of the at least two variable values of the receiver test value generator is identical to the variable value of the second sensor device of the two sensor devices. Furthermore, the phrase is intended to express that the receiver test value generator can (additionally or alternatively) have at least two (different) calculation rules, wherein a first calculation rule of the at least two calculation rules of the receiver test value generator is identical to the calculation rule of a first sensor device of the two sensor devices, and wherein a second calculation rule of the at least two calculation rules of the receiver test value generator is identical to the calculation rule of the second sensor device of the two sensor devices.

The system can, for example, also have a multiplicity of sensor devices, wherein each of the sensor devices has one sensor test value generator in each case with at least one variable value and with at least one calculation rule for calculating a sensor test value from the respective sensor measurement information to be communicated, wherein the variable values of the sensor test value generators and/or the calculation rules of the sensor test value generators of the multiplicity of sensor devices are different, in particular are individual. The multiplicity of sensor device is, in particular, at least three sensor devices, preferably four sensor devices.

In particular, the receiver test value generator of the receiver device has every variable value of the sensor test value generators of a multiplicity of sensor devices and/or every calculation rule of the sensor test value generators of the multiplicity of sensor devices.

The data packet can be sent through the transmission channel to the receiver device, in particular as a digital signal, preferably as a binary signal. In particular, the binary signal includes a series of pulses or is represented by a series of pulses.

Advantageously, the communication of information between at least two sensor devices and the receiver device can take place especially simply, safely, and quickly with the method according to the invention. As a result of the fact that the receiver device selects the variable value and/or the calculation rule as a function of the sensor device, in particular as a function of the sensor device to be communicating with the receiver device, a sending of a sensor identification number with the data packet can be omitted, for instance. For instance, the variable value of the sensor test value generator of the sensor device can represent the sensor identification number as a piece of information of the sensor device. Thus, for example, if a sensor device that was not queried or not expected by the receiver device sends a data packet, the checking of the received sensor measurement information of the data section of the data packet based on the received sensor test value and the calculated receiver test value fails with an especially high probability, since the variable value used by the receiver test value generator and the variable value used by the sensor test value generator are different. On the other hand, received sensor measurement information can be associated with a specific sensor device especially safely and reliably when the received sensor test value and the calculated sensor test value agree. Moreover, the data packet can be transmitted especially quickly, since the transmission of a piece of information such as the sensor identification number of the sensor device or of a sensor of the sensor device and/or the transmission of at least a status such as the functionality of the sensor device or of a sensor of the sensor device can be omitted.

It can be advantageous in a method according to the invention when the variable value of the sensor test value generator and/or the calculation rule of the sensor test value generator reproduce or represent at least one piece of information and/or at least one status of the sensor device, preferably at least one piece of information and/or at least one status of a sensor of the sensor device. For instance, the variable value of the sensor test value generator of a sensor device can represent a sensor identification number as a piece of information of the sensor device. A sending by the sensor device of a sensor identification number with the data packet can thus advantageously be omitted. It is also possible that, for instance, the variable value of the sensor test value generator of a sensor device represents a functionality of the sensor device such as “operational” or “faulty.” The sensor test value generator of the sensor device can, in particular, also have multiple variable values and/or multiple calculation rules. Consequently, multiple different pieces of information and/or multiple different statuses of the sensor device or of a sensor of the sensor device can be reproduced or represented with the multiple variable values of the sensor test value generator and/or with the multiple calculation rules of the sensor test value generator. The receiver device according to the invention or the receiver test value generator then accordingly has, in particular, the multiple variable values of the sensor test value generator and/or the multiple calculation rules of the sensor test value generator.

It can be advantageous in a method according to the invention when the receiver device sends a query to at least one of the two sensor devices to request at least one data packet from the at least one sensor device. In other words, the receiver device can selectively query a sensor device, wherein the queried sensor device of the receiver device sends the data packet to the receiver device through the transmission channel. Consequently, the communication of information can be especially efficient. The receiver device can, for example, send a query to a sensor device to request at least one data packet from the at least one sensor device, wherein the receiver device preferably selects the variable value of the sensor test value generator of the queried sensor device, which value is stored on a storage of the receiver device, and/or selects the calculation rule of the sensor test value generator of the queried sensor device, which rule is stored on a storage of the receiver device, for the calculation of the receiver test value.

It can furthermore be advantageous in a method according to the invention when at least one of the two sensor devices automatically sends a data packet to the receiver device, at least at times. In other words, at least one of the two sensor devices can send or transmit a data packet to the receiver device unrequested, at least at times. Consequently, the communication of information between at least two sensor devices and the receiver device can take place especially simply and quickly, in particular since the requesting of at least one data packet from the at least one sensor device by the receiver device can be omitted, at least at times. The automatic sending of a data packet to the receiver device by at least one of the two sensor devices can take place in a transmission cycle, in particular.

Advantageously, in a method according to the invention the two sensor test value generators of the at least two sensor devices and the receiver test value generator of the receiver device can have the same calculation rule for calculation of the sensor test value or for calculation of the receiver test value, wherein the receiver test value generator, for example, has only the one calculation rule. In other words, the calculation rule of the receiver test value generator, the calculation rule of the sensor test value generator of one of the sensor devices of the two sensor devices, and the calculation rule of the sensor test value generator of the other sensor device of the two sensor devices are identical, wherein the variable value of the sensor test value generator of the one sensor device and the variable value of the sensor test value generator of the other sensor device of the two sensor devices differ, preferably are individual. For instance, the two sensor test value generators and the receiver test value generator can have a CRC method as calculation rule, wherein the two initial values of the two sensor devices for the CRC method differ, however. Consequently, the communication of information between a sensor device of the two sensor devices and the receiver device can be especially simple and fast. In particular, a sensor device and a receiver device can be designed and implemented especially simply.

To particular advantage, in a method according to the invention the two sensor devices can each send at least one data packet to the receiver device in time alternation, at least at times. In particular, the two sensor devices each send at least one data packet to the receiver device in time alternation, at least at times, in such a manner that the sending does not substantially overlap in time or does not overlap in time at all. Consequently, the communication of information from the two sensor devices or multiple sensor devices of the system according to the invention to the receiver device can take place especially free of interference. Furthermore, the receiver device can be designed especially simply, since one receiving unit of the receiver device can sequentially receive and process data packets from different sensor devices, at least at times.

Also, in the method according to the invention the two sensor devices can each send at least one data packet to the receiver device, simultaneously at least at times or overlapping in time at least at times. Consequently, the communication of information of the two sensor devices or multiple sensor devices of the system according to the invention to the receiver device can take place especially simply. In particular, the two sensor devices or multiple sensor devices advantageously can send data packets to the receiver device on an ongoing basis, at least at times, or on an ongoing basis and automatically, at least at times. The receiver device can have a separate receiving unit for each of the multiple sensor devices for receiving the data packets. The receiver device can, in particular, have a buffer for buffering the data packets of the two sensor devices or for buffering the data packets of the multiple sensor devices. Furthermore, the receiver test value generator of the receiver device can have a respective separate sub-receiver test value generator for each of the two sensor devices or each of the multiple sensor devices, wherein each sub-receiver test value generator has the relevant variable value of the sensor test value generator and/or the relevant calculation rule of the sensor test value generator of the sensor device associated with the sub-receiver test value generator. Consequently, the communication of information from the two sensor devices or multiple sensor devices of the system according to the invention to the receiver device and/or the checking of the received sensor measurement information for transmission errors can take place especially efficiently.

It can be advantageous when at least one of the two sensor devices generates and/or sends a data packet with the data section; with the test section; and with a count section with a counter value, wherein the counter value is changed, in particular increased, for each sending of a data packet by the at least one sensor device; and/or with a status section for transmitting a status of the sensor device, in particular a fault condition of the sensor device; and/or with a serial section for serial transmission of sensor auxiliary information of the sensor device. It is advantageously possible to check by means of the counter value whether a sensor device is still operational. If, for example, a sensor device does not increment the counter value, then a fault or error of the sensor device can be inferred. In addition, a serial section can advantageously transmit partial sensor auxiliary information such as, e.g., a temperature of the sensor device, in each data packet, wherein preferably the complete sensor auxiliary information such as, e.g., the temperature, is only transmitted to the receiver device after multiple data packets.

Provided also is a receiver device for a method according to the invention, wherein the receiver device has a receiver test value generator with at least two variable values and/or with at least two calculation rules for calculation of a receiver test value.

In particular, the receiver test value generator of the receiver device can have a separate sub-receiver test value generator in each case for each of the two sensor device or each of the multiple sensor devices for calculating a respective receiver test value.

A receiver device according to the invention can have a selection unit for selection of a variable value as a function of a sensor device and/or for selection of a calculation rule as a function of a sensor device. If, for instance, the receiver device sends a query to at least one of the two sensor devices to request at least one data packet from the at least one sensor device, then the selection unit selects the variable value and/or the calculation rule of the queried sensor device for the calculation of the receiver test value. It is furthermore also possible, in particular, that both sensor devices automatically send a data packet or data packets to the receiver device, wherein the selection unit automatically selects the variable values as a function of the sensor device and/or automatically selects the calculation rule as a function of the sensor device. For instance, the selection unit can automatically select the variable value and/or the calculation rule of a first sensor device of the at least two sensor devices and the variable value and/or the calculation rule of a second sensor device of the at least two sensor devices in alternation for this purpose. The selection unit can be implemented at least partly by hardware and/or at least partly by software.

The receiver device can have an error detection unit for checking received sensor measurement information of a data section of a data packet from a sensor device based on a received sensor test value of a test section of the data packet from the sensor device and a calculated receiver test value. The error detection unit can, in particular, compare the received sensor test value of the test section of the data packet from the sensor device and the calculated receiver test value in order to detect a transmission error. If, in particular, the sensor test value and the receiver test value are identical, it can be assumed that no transmission error has occurred. If, in particular, the sensor test value and the receiver test value are different, it can be assumed that a transmission error has occurred, caused, for example, by external interference. The error detection unit can be implemented at least partly by hardware and/or at least partly by software.

Furthermore, the receiver device can have a receiving unit for receiving the data packet, in particular for receiving data packets. The receiving unit can be implemented at least partly by hardware and/or at least partly by software. In particular, the receiver device can have a separate receiving unit for each of the at least two sensor devices for receiving the data packets.

The receiver device thus has the same advantages as have already been described in relation to the method according to the first aspect of the invention.

Provided is also a sensor device for a method according to the invention, wherein the sensor device has a sensor test value generator with a variable value and with a calculation rule for calculating a sensor test value, wherein, in particular, the sensor test value generator has multiple variable values and/or multiple calculation rules.

The sensor device thus has the same advantages as have already been described in relation to the method according to the first aspect of the invention or, respectively, in relation to the receiver device according to the second aspect of the invention.

The present invention also discloses a system, in particular for a vehicle, composed of a receiver device and at least two sensor devices for communicating information between the sensor devices and the receiver device through a transmission channel of the system, wherein the system is designed and implemented to carry out a method according to the invention, wherein preferably the receiver device is designed according to the invention, and wherein preferably the at least two sensor devices are each designed according to the invention.

It can be advantageous in a system according to the invention when the transmission channel has at least two electrical conductors, wherein, in particular, the transmission channel has a supply signal conductor for supplying the at least two sensor devices with electric power and for transmitting information that is to be communicated, preferably for transmitting a data packet, as well as a ground conductor, or wherein the transmission channel has at least three electrical conductors, wherein, in particular, the transmission channel has a supply conductor for supplying the at least two sensor devices with electric power, a ground conductor, as well as at least one signal conductor for transmitting information that is to be communicated, preferably for transmitting a data packet.

Preferably, the communication of information between the sensor devices of the system and a receiver device of the system can be unidirectional. In other words, in normal operation the sensor device can only send information to the receiver device, but cannot receive any information from the receiver device.

Advantageously, a system according to the invention can have a common transmission channel for the receiver device and the at least two sensor devices, wherein the receiver device and the at least two sensor devices each have a direct communication connection to the transmission channel. In other words, the system according to the invention can have, in particular, a bus system for communicating information between the sensor devices and the receiver device.

The system according to the fourth aspect of the invention thus has the same advantages as have already been described in relation to the method according to the first aspect of the invention or, respectively, in relation to the receiver device according to the second aspect of the invention or, respectively, in relation to the sensor device according to the third aspect of the invention.

Additional measures that improve the invention are evident from the description below regarding some exemplary embodiments of the invention that are schematically represented in the figures. All features and/or advantages, including design details, spatial arrangements, and method steps, that derive from the claims, the description, or the drawings, can be essential for the invention individually as well as in a variety of combinations. It should be noted in this regard that the figures have a merely descriptive character and are not intended to restrict the invention in any form.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of a method according to the invention,

FIG. 2 is an example of a receiver device according to the invention,

FIG. 3 is an example of a sensor device according to the invention,

FIG. 4 is an example of a system according to the invention,

FIG. 5 is another example of a system according to the invention,

FIG. 6 is an example of a data packet, and

FIG. 7 is an example of a sensor test value generator.

### DETAILED DESCRIPTION

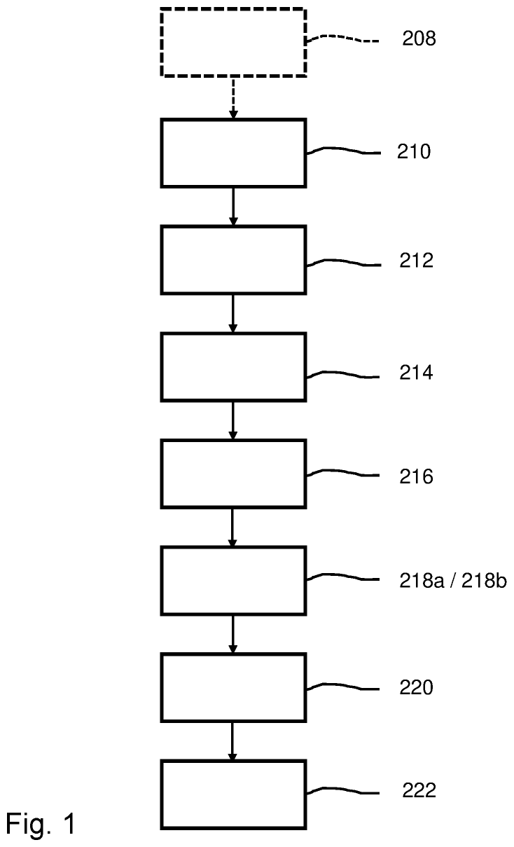

FIG. 1 shows an embodiment of a method according to the invention for communicating information between a sensor device 10a according to the invention of a system 100 and a receiver device 50 according to the invention of the system 100, wherein the system 100 has at least two sensor devices 10a, 10b. As one step, the method has a calculation 210 of a sensor test value 28a by a sensor test value generator 12a of the sensor device 10a, as a function of a variable value 30a and/or as a function of a calculation rule 32a, from at least sensor measurement information 24a to be communicated. As another step, a generation 212 of a data packet 70a takes place, wherein the data packet 70a has, at a minimum, a data section 72 with the sensor measurement information 24a to be communicated and a test section 74 with the calculated sensor test value 28a. A sending 214 of the data packet 70a through a transmission channel 102a to the receiver device 50 takes place as another step. Furthermore, a receiving 216 by the receiver device 50 of the data packet 70a from the sensor device 10a takes place as another step. In addition, a selection 218a by the receiver device 50 of the variable value 30a of the sensor test value generator 12a as a function of the sensor device 10a and/or selection 218b by the receiver device 50 of the calculation rule 32a of the sensor test value generator 12a as a function of the sensor device 10a takes place as another step. Furthermore, a calculation 220 by the receiver test value generator 52 of a receiver test value with the selected variable value 30a and/or with the selected calculation rule 32a from at least the received sensor measurement information 24a to be communicated of the data section 72 of the data packet 70a takes place as a step, as well as a checking 222 of the received sensor measurement information 24a of the data section 72 of the data packet 70a for a transmission error based on the received sensor test value 28a and the calculated receiver test value. In particular, the method can have, as an additional step, the sending 208 of a query by the receiver device 50 to at least one of the two sensor devices 10a, 10b to request at least one data packet 70a from the at least one sensor device 10a, 10b. It is furthermore also possible, in particular, that at least one of the two sensor devices 10a, 10b automatically sends a data packet 70a, 70b to the receiver device 50, at least at times, which is to say without a prior query from the receiver device 50.

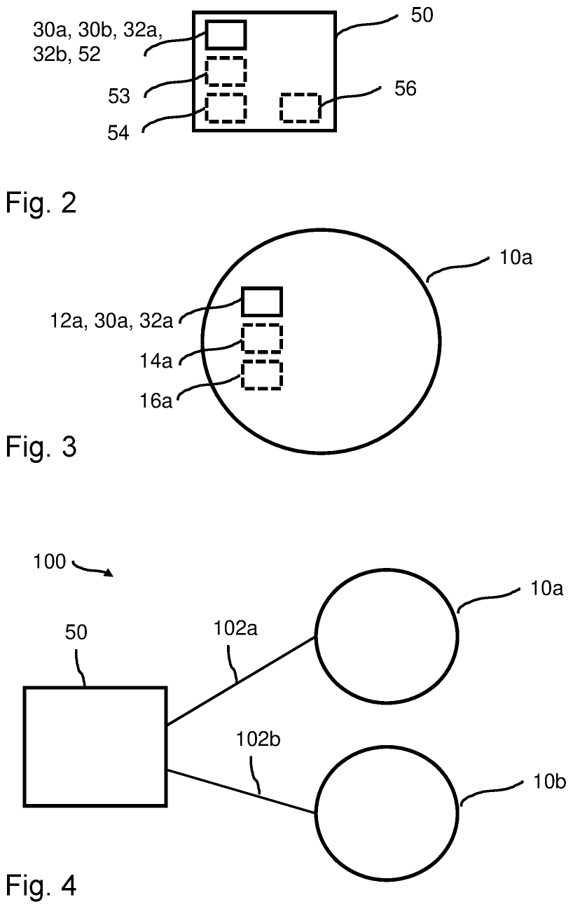

FIG. 2 schematically shows an embodiment of a receiver device 50 according to the invention, wherein the receiver device 50 has a receiver test value generator 52 with at least two variable values 30a, 30b and/or with at least two calculation rules 32a, 32b for calculating a receiver test value. Furthermore, the receiver device 50 can additionally have a selection unit 53 for selecting a variable value 30a, 30b as a function of a sensor device 10a, 10b and/or for selecting a calculation rule 32a, 32b as a function of a sensor device 10a, 10b. Moreover, the receiver device 50 can additionally have an error detection unit 56 for checking received sensor measurement information 24a, 24b of a data section 72 of a data packet 70a, 70b from a sensor device 10a, 10b based on a received sensor test value 28a, 28b of a test section 74 of the data packet 70a, 70b from the sensor device 10a, 10b and a calculated receiver test value. Also, the receiver device 50 can have at least one receiving unit 54 for receiving data packets 70a, 70b.

FIG. 3 schematically shows an embodiment of a sensor device 10a according to the invention, wherein the sensor device 10a has a sensor test value generator 12a with a variable value 30a, 30b and with a calculation rule 32a for calculating a sensor test value 28a. Moreover, the sensor device 10a can additionally have a data packet generator 14a for generating a data packet 70a. Furthermore, the sensor device 10a can additionally include a transmitting unit 16a, wherein the transmitting unit 16a is designed to send the data packet 70a to the receiver device 50.

FIG. 4 schematically shows an embodiment of a system 100 according to the invention, wherein the system has a receiver device 50 according to the invention and at least two sensor devices 10a, 10b according to the invention for communicating information between the sensor devices 10a, 10b and the receiver device 50 through a transmission channel 102a, 102b of the system 100. In FIG. 4, each sensor device 10a, 10b has a separate communication connection to the receiver device through a transmission channel 102a or 102b, preferably (only) by means of a supply conductor, a ground conductor, and a signal conductor in each case.

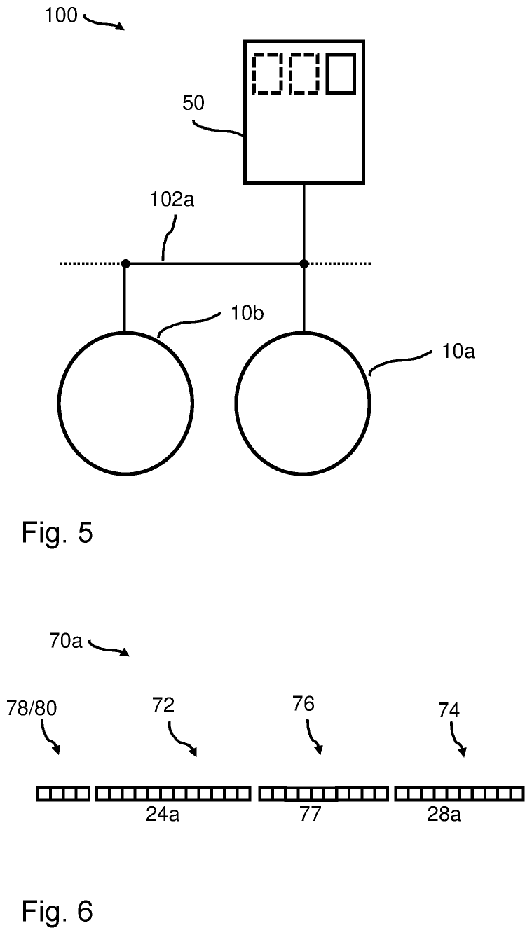

FIG. 5 schematically shows another embodiment of a system 100 according to the invention, wherein the system has a receiver device 50 according to the invention and at least two sensor devices 10a, 10b according to the invention for communicating information between the sensor devices 10a, 10b and the receiver device 50 through a transmission channel 102a of the system 100. The system 100 here has a common transmission channel 102a for the receiver device 50 and the at least two sensor devices 10a, 10b, wherein the receiver device 50 and the at least two sensor devices 10a, 10b each have a direct communication connection to the transmission channel 102a.

FIG. 6 shows an embodiment of a data packet 70a, wherein the data packet 70a includes a data section 72 with the sensor measurement information 24a to be communicated, a test section 74 with the sensor test value 28a, a count section 76 with a count value 77 (so-called “rolling counter”), and a status section 78/serial section 80. Preferably, the status section 78/serial section 80 is 4 bits long. Furthermore, the data section 72 is preferably 24 bits long, wherein, in particular, 12 bits of the 24 bits of the data section 72 are associated with sensor measurement information of a first sensor of the sensor device 10a and the remaining 12 bits of the 24 bits of the data section 72 are associated with sensor measurement information of another sensor of the sensor device 10a. In particular, the count section 76 is 8 bits long. In like manner, the test section 74, in particular, is 8 bits long.

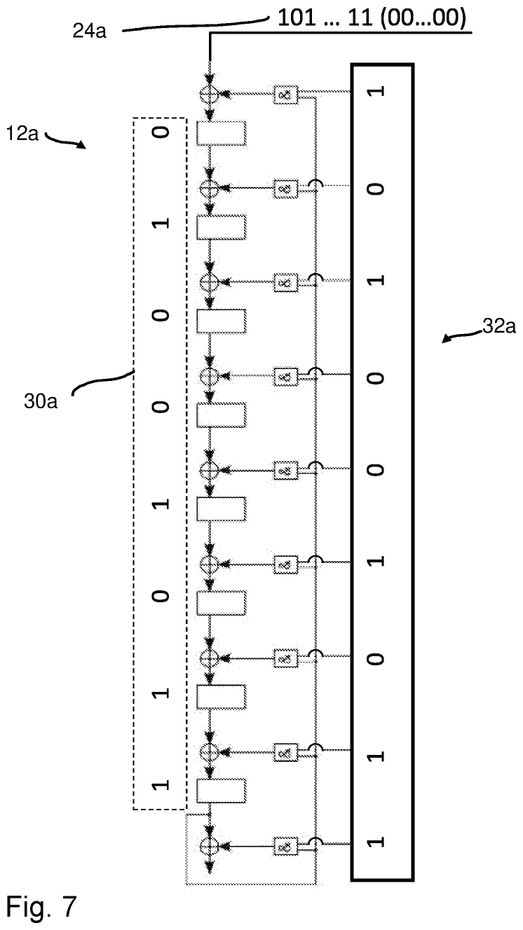

FIG. 7 shows, by way of example, an embodiment of a sensor test value generator 12a—at least partly in hardware—of a sensor device 10a for calculating a CRC sensor test value as sensor test value 28a. At the start of a cyclic redundancy check (CRC method) as calculation rule 32a, a CRC initial test value as variable value is, as shown in FIG. 7, the initial value of the shift register (here: 11010010). In the CRC method, sensor measurement information 24a is modulo divided by a generator polynomial (here: 110100101) by means of polynomial division. The division is implemented here through shift registers. Once the sensor measurement information 24a is modulo divided by the generator polynomial, the CRC sensor test value can be determined or “read out” as sensor test value 28a from the shift registers as the remainder from the division, wherein the CRC sensor test value as sensor test value 28a is influenced by the choice of the CRC initial test value as variable value 30a or depends on the choice of the CRC initial test value as variable value 30a.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for a vehicle to communicate information between a sensor device of a system and a receiver device of the system, wherein the system has at least two sensor devices, wherein the two sensor devices each have a sensor test value generator with at least one variable value and with a calculation rule for calculating a sensor test value from respective sensor measurement information to be communicated, wherein the variable values of the sensor test value generators and/or the calculation rules of the sensor test value generators of the two sensor devices are different, and wherein the receiver device has a receiver test value generator with at least the two variable values of the sensor test value generators and/or with at least the two calculation rules of the sensor test value generators of the two sensor devices, the method comprising:
calculating by the sensor test value generator, the sensor test value as a function of the variable value and/or as a function of the calculation rule from at least the sensor measurement information to be communicated;
generating a data packet, wherein the data packet has at least a data section with the sensor measurement information to be communicated and a test section with the calculated sensor test value;
sending the data packet through a transmission channel to the receiver device;
receiving, by the receiver device, the data packet from the sensor device;
selecting, by the receiver device, the variable value of the sensor test value generator as a function of the sensor device and/or selection by the receiver device of the calculation rule of the sensor test value generator as a function of the sensor device;
calculating, by the receiver test value generator, a receiver test value with the selected variable value and/or with the selected calculation rule from at least the received sensor measurement information to be communicated of the data section of the data packet; and
checking the received sensor measurement information of the data section of the data packet for a transmission error based on the received sensor test value and the calculated receiver test value.

2. The method according to claim 1, wherein the variable value of the sensor test value generator and/or the calculation rule of the sensor test value generator reproduce or represent at least one piece of information and/or at least one status of the sensor device or at least one piece of information and/or at least one status of a sensor of the sensor device.

3. The method according to claim 1, wherein the receiver device sends a query to at least one of the two sensor devices to request at least one data packet from the at least one sensor device.

4. The method according to claim 1, wherein at least one of the two sensor devices automatically sends a data packet to the receiver device, at least at times.

5. The method according to claim 1, wherein the two sensor test value generators of the at least two sensor devices and the receiver test value generator of the receiver device have the same calculation rule for calculation of the sensor test value or for calculation of the receiver test value, and wherein the receiver test value generator has only the one calculation rule.

6. The method according to claim 1, wherein the two sensor devices each send at least one data packet to the receiver device in time alternation, at least at times.

7. The method according to claim 1, wherein the two sensor devices each send at least one data packet to the receiver device substantially simultaneously at least at times or overlapping in time at least at times.

8. The method according to claim 1, wherein at least one of the two sensor devices generates and/or sends a data packet with the data section with the test section and with a count section with a counter value, wherein the counter value is changed or increased for each sending of a data packet by the at least one sensor device, and/or with a status section for transmitting a status of the sensor device or a fault condition of the sensor device and/or with a serial section for serial transmission of sensor auxiliary information from the sensor device.

9. A receiver device for the method according to claim 1, wherein the receiver device has a receiver test value generator with at least two variable values and/or with at least two calculation rules for calculation of a receiver test value.

10. The receiver device according to claim 9, wherein the receiver device has a selection unit to select a variable value as a function of a sensor device and/or to select a calculation rule as a function of a sensor device.

11. The receiver device according to claim 9, wherein the receiver device has an error detection unit for checking received sensor measurement information of a data section of a data packet from a sensor device based on a received sensor test value of a test section of the data packet from the sensor device and a calculated receiver test value.

12. A sensor device for the method according to claim 1, wherein the sensor device has a sensor test value generator with a variable value and with a calculation rule for calculating a sensor test value, and wherein the sensor test value generator has multiple variable values and/or multiple calculation rules.

13. A system for a vehicle, the sensor comprising:
a receiver; and
at least two sensors to communicate information between the sensors and the receiver through a transmission channel of the system, wherein the system is configured to carry out the method according to claim 1.

14. The system according to claim 13, wherein the transmission channel has at least two electrical conductors, wherein the transmission channel has a supply signal conductor for supplying the at least two sensor devices with electric power and for transmitting information that is to be communicated or for transmitting a data packet, as well as a ground conductor, or wherein the transmission channel has at least three electrical conductors, wherein the transmission channel has a supply conductor for supplying the at least two sensor devices with electric power, a ground conductor, and at least one signal conductor for transmitting information that is to be communicated or for transmitting a data packet (70a, 70b).

15. The system according to claim 13, wherein the system has a common transmission channel for the receiver and the at least two sensors, and wherein the receiver and the at least two sensors each have a direct communication connection to the transmission channel.
